(19) United States
(12) Patent Application Publication
(10) Pub. No.: US 2003/0219110 A1
(43) Pub. Date: Nov. 27, 2003

(54) Mobile communication device and method thereof for changing formats of ring tones

(76) Inventors: Shih-Kuang Tsai, Taipei Hsien (TW); Xiao-Feng Mao, Shanghai (CN)

Correspondence Address: NAIPO (NORTH AMERICA INTERNATIONAL PATENT OFFICE), P.O. BOX 506, MERRIFIELD, VA, 22116, US

(21) Appl. No.: 10/063,881

(22) Filed: May 21, 2002

(51) Int. Cl. H04M 1/00; H04M 3/00

(52) U.S. Cl. 379/373.01

(57) ABSTRACT

A mobile communication device has a storage module for storing at least a first format and a conversion rule associated with the first format, a receiving module for receiving a first ring tone data, a processor electrically connected to the storage module and the receiving module for determining whether the first ring tone data comply with the first format, and a conversion module electrically connected to the processor and the storage module for converting the first ring tone data complying with the first format into a second ring tone data complying with a second format according to the conversion rule. When the first ring tone data comply with the first format, the conversion module is activated to generate the second ring tone data so that the mobile communication device can play a ring tone according to the second ring tone data.

### BACKGROUND OF THE INVENTION

1. Field of the Invention

The present invention relates to a mobile communication device, and more particularly, to a mobile communication device and a method thereof for changing formats of ring tones.

2. Description of the Prior Art

With advanced development of communication technology, mobile communication devices have become some of the most popular tools among consumers. In addition, functionality of mobile communication devices has become more complex than before, and is now applied in a broad spectrum of fields. Generally speaking, mobile communication devices use a ring tone to inform a user about an incoming phone call. Recently, users have enjoyed using a mobile communication device with a unique ring tone to differentiate from other people. Therefore, many kinds of ring tones have been composed to meet demands of users, and users can download those ring tones from a server to a mobile communication system via a network for establishing a personalized ring tone. Furthermore, different brands of mobile communication devices respectively provide special ring tones for users. However, if many users use the same brand of mobile communication devices, a ring tone used by one user may be identical to that used by others.

Therefore, the function of editing the ring tone has become a fundamental feature of each mobile communication device. However, each brand of the mobile communication device has defined its own format of ring tone data. The mobile communication device usually adopts a numbered musical notation that is used to edit a ring tone owing to a limited number of keys on a keypad of the mobile communication device. Then, the user can edit unique ring tone data by pressing a series of keys to compose a specific ring tone.

However, if the user replaces the original mobile communication device with a different brand of mobile communication device, the existing ring tone data stored on the previous mobile communication device cannot be used by the new mobile communication device because of a different ring tone format. In other words, the user must edit his favorite ring tone again according to a new format defined by the new mobile communication device. The user, therefore, must spend considerable time in learning the new format in order to correctly edit a favorite ring tone. Otherwise, the user has to use default ring tones originally stored in the mobile communication device, and the ring tones are too common to have any distinctive features for the user. To sum up, it is very inconvenient for the user to edit the same ring tone repeatedly when different mobile communication devices are used.

### SUMMARY OF INVENTION

It is therefore a primary objective of the claimed invention to provide a mobile communication device with a function of changing formats of ring tones to solve the above-mentioned problem.

Briefly, the claimed invention provides a ring tone format conversion method used in a mobile communication device. The mobile communication device is capable of playing at least a ring tone according to an associated ring tone data complying with a predetermined format to inform a user of a call. The ring tone format conversion method includes receiving a first ring tone data complying with a first format, and converting the first ring tone data complying with the first format into a second ring tone data complying with the predetermined format according to a predetermined conversion rule. Both the first ring tone data and the second ring tone data correspond to an identical ring tone.

It is an advantage of the claimed invention that the claimed mobile communication device can automatically recognize different formats and convert those formats into a desired format that is adopted by the claimed mobile communication device so that the user can conveniently use the same ring tone in different brands of mobile communication devices without editing corresponding ring tone data repeatedly.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a block diagram of a mobile communication device that can convert one ring tone format into another ring tone format according to the present invention.

FIG. 2 is a flow chart of a conversion method for the mobile communication device shown in FIG. 1.

### DETAILED DESCRIPTION

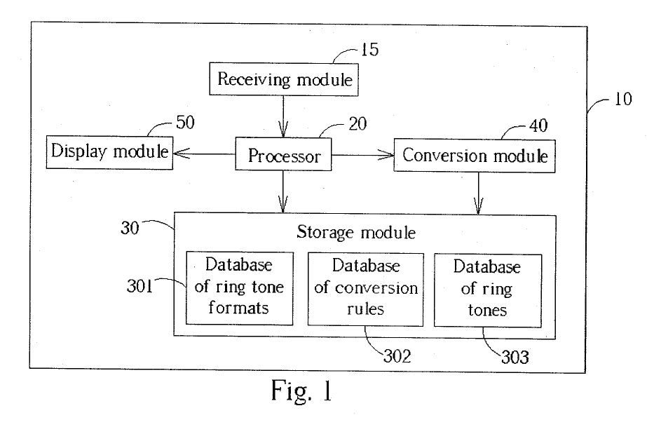

Please refer to FIG. 1, which is a block diagram of a mobile communication device 10 that can convert one ring tone format into another ring tone format according to the present invention. The mobile communication device 10 such as a cellular phone has a receiving module 15, a processor 20, a storage module 30, a conversion module 40, and a display module 50. The receiving module 15 is electrically connected to the processor 20. The processor 20 is electrically connected to the conversion module 40, the display module 50, and the storage module 30. The conversion module 40, in addition, is electrically connected to the storage module 30. The storage module 30 has a database of ring tone formats 301, a database of conversion rules 302, and a database of ring tones 303. The database of ring tone formats 301 records at least a ring tone format so that the processor 20 can access the stored ring tone format to identify received ring tone data. The database of conversion rules 302 records a corresponding conversion rule associated with the ring tone format stored in the database of ring tone formats 301 so that the conversion module 40 can access the conversion rule to convert format of the received ring tone data into another format.

The database of ring tones 303 records ring tone data that are compatible with a playback format required by the mobile communication device 10.

The operation of the mobile communication device 10 according to the present invention is described as follows. The receiving module 15 first receives a first ring tone data complying with a first format. The processor 20 then identifies format of the received first ring tone data according to the formats stored in the database of ring tone formats 301. If the first format of the received first ring tone data is recognized as a valid format by the processor 20, the conversion module 40 is activated to convert the first ring tone data complying with the first format into a second ring tone data complying with a second format according to a conversion rule related to a mapping between the first format and the second format. Please note that the mobile communication device 10 only plays ring tones complying with the second format. In other words, ring tone formats other than the second format are not compatible with requirements of the mobile communication device 10. After the conversion operation is completed, the second ring tone data are stored in the database of ring tones 303 so that the user can select one favorite ring tone from the database of ring tones 303.

In addition, the display module 50 can inform the user about a current operation status of the mobile communication device 10. For example, if the processor 20 can not recognize the first format of the received first ring tone data according to the database of ring tone formats 301, the display module 50 will inform the user that the first ring tone data complying with the first format are invalid.

Regarding the identification of ring tone formats and the conversion of ring tone formats according to the present invention, three common ring tone formats, for example, are described as follows.

(1) The first character of the ring tone data is a number ranging from “1” to “4” for representing speed of the corresponding ring tone. A blank space then follows the first character. Only two characters in the beginning are used to identify this kind of ring tone data owing to the special combination of characters.

(2) The beginning of the ring tone data represents a musical notation. For example, a first part of the musical notation is a single character such as “1”, “2”, “4”, or “8” individually standing for a semibreve, a minim, a crotchet, or a quaver. Double characters such as “16” or “32” stand for a semiquaver or a demisemiquaver. In addition, a character such as “.”, “−”, or “#” may be annexed to the first part of the musical notation to represent a dotted note, a rest, or a semitone. A second part of the musical notation is a character ranging from “a” to “g” standing for a musical alphabet. That is, when the first character of the ring tone data is a number such as “2”, “4”, or “8”, the processor 20 reads the second character to determine whether the second character is a musical alphabet, a dotted note, a rest, or a semitone. If the second character is a musical alphabet, a dotted note, a rest, or a semitone, then this kind of ring tone data is recognized. Furthermore, when the first and second characters of the ring tone data are numbers such as “16”, or “32”, the processor 20 reads the third character to determine whether the third character is a musical alphabet, a dotted note, a rest, or a semitone. If the third character is a musical alphabet, a dotted note, a rest, or a semitone, then this kind of ring tone data is recognized.

(3) This kind of ring tone data uses capital letters ranging from “A” to “G” and lowercase letters ranging from “a” to “g” to represent musical alphabets wherein the capital letter stands for acrotchet, and the lowercase letter stands for a quaver. The character “+” represents an octave, the character “p” represents a rest, and the character “#” represents a semitone. All of the characters “+”, “p”, and “#” are defined to be placed prior to the capital or lowercase letters. Therefore, when the first character of the ring tone data is a capital or a lowercase letter, the processor 20 reads the second character to determine whether the second character is a blank space or a finish mark. If the second character is a blank space or a finish mark, this kind of ring tone data is recognized. However, if the first character of the ring tone data is a symbol such as “p”, “#”, or “+”, this kind of ring tone data is directly recognized owing to the special arrangement of characters.

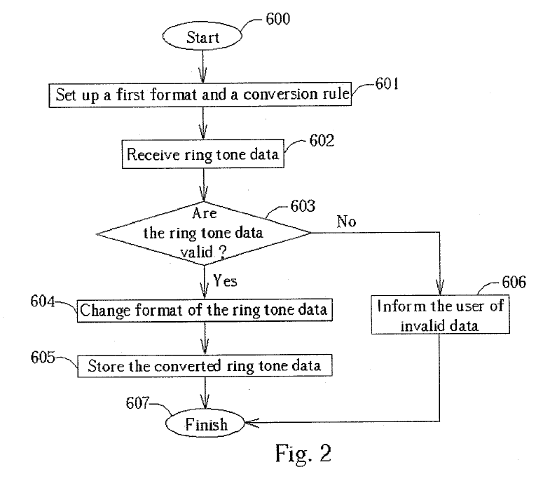

Please refer to FIG. 2, which is a flow chart of a conversion method for the mobile communication device 10 shown in FIG. 1. The operation of the mobile communication device 10 has following steps.

Step 600: Start;

Step 601: Set up a first format and a conversion rule related to the first format;

Step 602: Receive a first ring tone data;

Step 603:

Identify the first ring tone data according to the first format to determine whether the first ring tone data are valid. If the first ring tone data are valid, go to step 604; otherwise, go to step 606;

Step 604:

Convert the first ring tone data complying with the first format into second ring tone data complying with a second format;

Step 605: Store the second ring tone data. Go to Step 607;

Step 606: lnform a user that the first ring tone data are invalid;

Step 607: Finish.

The user sets up a plurality of valid receiving formats stored in the database of ring tone formats 301. In addition, a plurality of conversion rules with regard to the valid receiving formats are also recorded in the database of conversion rules 302 (step 601). After ring tone data with a specific format different from the ring tone format of the mobile communication device 1 0 are received (step 602), the processor 20 is activated to determine whether the ring tone data with the specific format are valid (step 603). If the ring tone data with the specific format are valid, that is, the specific format has been defined in the database of ring tone formats 301, the conversion module 40 is activated to convert the received ring tone data complying with the specific format into corresponding ring tone data complying with a unique format that is adopted by the mobile communication device 10 (step 604). The converted ring tone data are then stored in the database of ring tones 303 so that the user can choose the converted ring tone data in the future (step 605). However, if the ring tone data with the specific format are invalid, that is, the specific format is not yet defined in the database of ring tone formats 301, related information is displayed by the display module 50 to inform the user that something is wrong (step 606). Please note that the received ring tone data and the corresponding converted ring tone data both refer to the same ring tone.

In contrast to the prior art mobile communication device, the claimed mobile communication device has at least a ring tone format and a conversion rule related to the ring tone format. When receiving ring tone data that are not compatible with the desired format, the mobile communication device first identifies format of the received ring tone data, and then converts the received ring tone data into new ring tone data that are compatible with the desired format according to an appropriate conversion rule. In conclusion, the claimed mobile communication device can automatically recognize different formats and convert those formats into a desired format that is adopted by the claimed mobile communication device so that the user can conveniently use the same ring tone in different brands of mobile communication devices without editing corresponding ring tone data repeatedly.

Those skilled in the art will readily observe that numerous modifications and alterations of the device may be made while retaining the teaching of the invention. Accordingly, the above disclosure should be construed as limited only by the metes and bounds of the appended claims.

1. A format conversion method for changing format of ring tone data used by a mobile communication device, the mobile communication device being capable of playing at least a ring tone according to an associated ring tone data complying with a predetermined format to inform a user of a call, the format conversion method comprising:
receiving a first ring tone data complying with a first format; and
converting the first ring tone data complying with the first format into a second ring tone data complying with the predetermined format according to a predetermined conversion rule;
wherein both the first ring tone data and the second ring tone data correspond to an identical ring tone.

2. The format conversion method of claim 1 wherein the mobile communication device comprises a database of ring tone formats for recording at least a first format related to the first ring tone data.

3. The format conversion method of claim 2 further comprising identifying first format of the first ring tone data according to the database of ring tone formats to determine whether the first ring tone data are valid.

4. The format conversion method of claim 2 wherein the mobile communication device further comprises a database of conversion rules for recording at least a predetermined conversion rule, and each predetermined conversion rule is individually associated with a first format of the first ring tone data.

5. The format conversion method of claim 1 further comprising storing the second ring tone data complying with the predetermined format.

6. The format conversion method of claim 1 wherein the mobile communication device further comprises a database of ring tones for recording the second ring tone data complying with the predetermined format.

7. The format conversion method of claim 1 wherein the mobile communication device is a cellular phone.

8. A mobile communication device comprising:
a storage module for storing at least a first format and a conversion rule associated with the first format;
a receiving module for receiving a first ring tone data;
a processor electrically connected to the storage module and the receiving module for determining whether the first ring tone data comply with the first format; and
a conversion module electrically connected to the processor and the storage module for converting the first ring tone data complying with the first format into a second ring tone data complying with a second format according to the conversion rule;
wherein when the first ring tone data comply with the first format, the conversion module is activated to generate the second ring tone data so that the mobile communication device can play a ring tone according to the second ring tone data.

9. The mobile communication device of claim 8 wherein the storage module comprises a database of ring tone formats for storing a plurality of first formats to identify the first ring tone data.

10. The mobile communication device of claim 9 wherein the storage module further comprises a database of conversion rules for storing a plurality of conversion rules, and each conversion rule is individually associated with a first format for converting the first format into the corresponding second format.

11. The mobile communication device of claim 8 wherein the storage module comprises a database of ring tones for storing the second ring tone data complying with the second format.

12. The mobile communication device of claim 8 being a cellular phone.

13. The mobile communication device of claim 8 further comprising a display module electrically connected to the processor for informing a user about operation status of the mobile communication device.

14. The mobile communication device of claim 13 wherein the display module informs the user that the first ring tone data are invalid when the first ring tone data are not complying with the first format.
